(19) United States
(12) Patent Application Publication
(10) Pub. No.: US 2026/0169837 A1
(43) Pub. Date: Jun. 18, 2026

(54) AUTOMATED PLANNING AND EXECUTION OF APPLICATION PROGRAMMING INTERFACES USING ARTIFICIAL INTELLIGENCE AGENTS

(71) Applicant: Maplebear Inc., San Francisco, CA (US)

(72) Inventor: Aomin Wu, Scarsdale, NY (US)

(21) Appl. No.: 18/985,066

(22) Filed: Dec. 18, 2024

(51) Int. Cl. G06F 9/54

(52) U.S. Cl. CPC G06F 9/547

(57) ABSTRACT

Embodiments describing automated planning and execution of functions using artificial intelligence (AI) agents are described. Functions may include, e.g., application programming interface (API) calls. A service request from a user device associated with a user is received. A planning AI agent (e.g., one or more machine-learning models) is prompted to generate, using a policy database, a sequence of one or more actions to address the service request. The policy database includes a plurality of policies for responding to various service requests. One or more functions (e.g., API calls) are identified to perform the sequence of one or more actions. An execution AI agent (e.g., one or more machine-learning models) is prompted to execute the one or more functions to resolve the service request. Once the service request has been resolved, the user device may be notified accordingly.

### BACKGROUND

Chatbots may be used by online platforms to resolve some types of customer issues. For example, a user may want to cancel their order with an online platform. The user would interact with a chatbot to request information on how to cancel an order. The chatbot may retrieve information and present it to the user regarding steps to take for the user to cancel the order. In some cases, the chatbot may not actually be able to cancel the order, but instead only be able to present information regarding steps the user should take to cancel the order. This is due in part to chatbots not having knowledge about the backend structure of the online platform and internal application programming interfaces that are used by the online platform to perform various actions. As such, conventional chatbots typically can perform information retrieval, but are not able to actually perform other actions (e.g., cancelling the order).

### SUMMARY

In accordance with one or more aspects of the disclosure, automated planning and execution of functions (e.g., application programming interface calls) using artificial intelligence (AI) agents is described. A service request from a user device (e.g., user client device) associated with a user is received. The service request may be received as part of an online chat session between the user and the online system. A planning AI agent (e.g., composed of one or more machine-learning models) is prompted to generate, using a policy database, a sequence of one or more actions to address the service request. The policy database includes a plurality of policies for responding to various service requests.

One or more functions (e.g., application programming interface (API) calls) are identified to perform the sequence of one or more actions. For example, one or more action entries are identified that correspond to the one or more actions, where an action entry provides context regarding a function. For example, in embodiments where the function is an API call, the context may include, e.g., a description, call parameters, and sample calls. The one or more action entries may be identified from a plurality of action entries of an action library, where each of the plurality of action entries is associated with a different function. In some embodiments, the functions associated with the action entries are functions (e.g., APIs) that are internal to the online system. An execution AI agent (e.g., composed of one or more machine-learning models) is prompted to execute the one or more functions to resolve the service request. Once the service request has been resolved, the user device may be notified accordingly. For example, the online system may notify the user via the online chat session.

For a given service request, a sequence of actions is automatically generated using policies of the online system. The policies provide specific domain knowledge of what actions should be taken to address various service requests in the context of the online system. Moreover, the action library includes action entries which provide specific domain knowledge regarding what functions (e.g., APIs) are available to the online system. As such, by associating each action of a sequence with a corresponding function of the action library, and executing the functions, the online system is able to ensure that service requests are resolved. In this manner, the planning AI agent and the execution AI agent are positioned to develop plans to resolve various service requests, and execute those plans (e.g., execute a series of API calls). Moreover, this is done in an autonomous manner and can resolve service requests over a wide range of issues (v. simply retrieving text and presenting it to the user).

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIG. 3A is an example sequence diagram describing updating an action library using a translation AI agent, in accordance with some embodiments.

FIG. 3B is an example sequence diagram describing automated resolution of service requests from user client devices, in accordance with some embodiments.

FIG. 4 is a flowchart for a method of automated planning and execution of functions using AI agents in accordance with some embodiments

### DETAILED DESCRIPTION

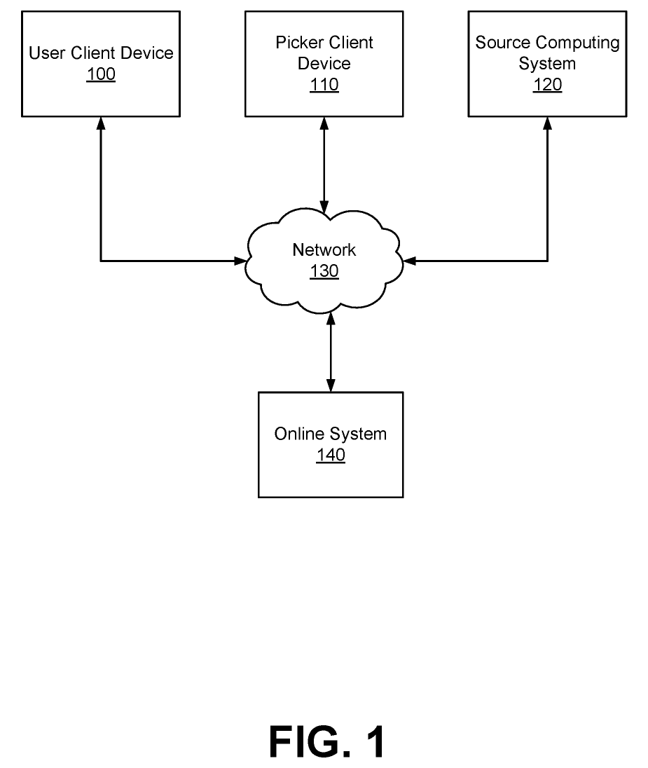

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. The user client device 100 may be referred to as a "user device." An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 generates a service request via a user interface (e.g., the ordering interface). The service request is a request for the online system 140 to perform a task (e.g., cancelling an order, rescheduling an order, etc.). The user client device 100 provides the service request to the online system 140. In some embodiments, the user client device 100 may commence an online chat session with the online system 140, and the user client device 100 may provide the service request during the online chat session. For example, the user may request in the online chat session that the online system 140 reschedule delivery of an order the user had previously made with the online system 140. Once the service request is resolved (e.g., a requested task is complete or the online system 140 determines that the task cannot be competed), the user client device 100 receives a notification from the online system 140. The user client device 100 may present the notification to the user via, e.g., the interface. The notification provides some description regarding the resolution to the task. For example, the user client device 100 may present in the online chat session the resolution to the service request (e.g., your order has successfully been re-scheduled).

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user’s order may specify which groceries they want to be delivered from the grocery store and the quantities of each of the groceries. The user client device 100 transmits the user’s order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 maintains an action library. The action library includes a plurality of action entries that each correspond to a different function that the online system 140 may call. A function may be, for example, an API call, or any other call that invokes a functionality of the online system 140 or one of its related services. The functions may be internal to the online system 140, external to the online system 140, or some combination thereof. The online system 140 may generate action entries by prompting a translation artificial intelligence (AI) agent to generate action entries for the action library using structured data (e.g., protobuf files that define interface of API calls). The generated action entries are added to the action library.

The online system 140 processes service requests from user client devices. The service requests may be received as part of online chat sessions with user client devices. The online system 140 uses a policy database and an AI planning agent to determine sequences of actions that address received service requests. The policy database includes a plurality of policies for responding to various service requests. For example, for a given service request, the online system 140 may prompt the planning AI agent to generate, using the policy database, a sequence of actions to address the service request. The online system 140 identifies functions (e.g., APIs) to perform sequences of actions using the action library.

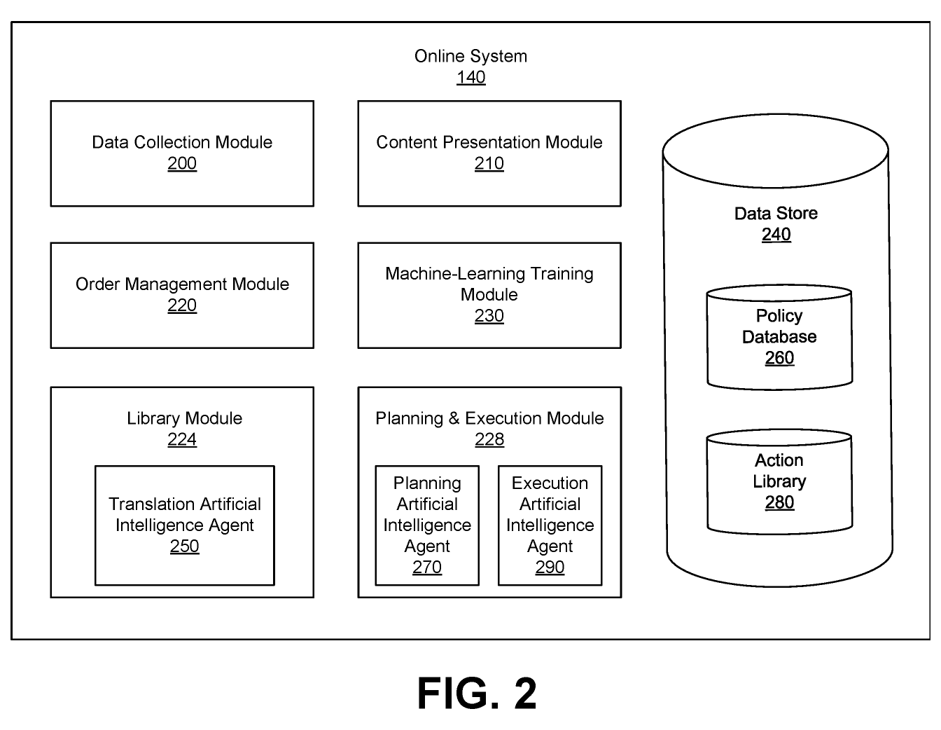

The online system 140 may then execute identified functions using an execution AI agent to resolve the service requests. In some embodiments, the execution AI agent may be composed of multiple machine learning models (e.g., a first and a second). The online system 140 may prompt a first machine learning model (e.g., large language model) to execute functions (e.g., API calls), and prompt a second machine-learning model (e.g., large language model) to evaluate results of executing the functions. In some embodiments, the second machine-learning model may identify errors in one or more of the results. For example, an error may be due to an error in a call parameter (e.g., input) of an executed API call. The second machine-learning model may determine a correction (e.g., update an input value) that should address the error, and then prompt the first large language model to call the API adjusted for the correction. Once a service request is resolved, the online system 140 notifies (e.g., via the online chat session, an email, etc.) the user client device accordingly. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a library module 224, a planning and execution module 228, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

The data collection module 200 collects service data. Service data is data that is associated with service requests. Service data may include, e.g., service requests received from user client devices, resolutions to the service requests, user feedback on resolutions to service requests, some other data associated with service requests, or some combination thereof.

While user data, picker data, source data, item data, service data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The library module 224 maintains an action library 280. The action library 280 includes a plurality of action entries that each correspond to a different function (e.g., API call) that the online system 140 may perform. The library module 224 includes a translation AI agent 250. The translation AI agent 250 may be composed of one or more machine learned models. The library module 224 may use the translation AI agent 250 to maintain the action library 280. Maintaining the action library 280 may include, e.g., generating new action entries, updating the action library with action entries, modifying action entries of the action library 280, etc.

An action entry is a high level description of a function. For example, a function may provide context to make a particular API call. As such, an action entry for a function describing an API may include a description of the API, call parameters for the API, and one or more sample calls for the API. The description of the API, the call parameters for the API, and the one or more sample calls for the API may be referred to as fields of an action entry. The description of an API describes (e.g., high level summary and/or title) the API. The call parameters of the API describe any inputs and outputs of the API. The one or more sample calls for an API are examples of executable code to call the API. For example, an order cancel API may have an action entry with: a description of "This API is for cancelling an order;" call parameters that include inputs (e.g., User ID, Order ID, Eligibility Flag) and an output (e.g., "cancel state (success/fail)"); and a sample call of e.g., "cancel_state = cancel_order(user_id=123, order ID = 456, eligibility = True).

The translation AI agent 250 may retrieve, from the data store 240, structured data that describes one or more functions (e.g., APIs) that can be performed by the online system 140. In some embodiments, the structured data associated with an API may be, e.g., one or more protocol buffers (may also be referred to as protobuf files) that fully describe interfaces of APIs used by the online system 140. The translation AI agent 250 may generate action entries for the action library 280 using the retrieved structured data. The translation AI agent 250 may update the action library 280 with the generated action entries. In this manner, the translation AI agent 250 can generate action entries for some or all of the functions that the online system 140 is able to utilize. These functions may be internal to the online system 140, external to the online system 140, or some combination thereof.

The policy database 260 stores a plurality of policies of the online system 140 regarding responding to service requests from user client devices. The policies describe steps that, e.g., an agent of the online system 140 would proceed through in order to respond to various types of service requests. Policies may include information (e.g., documents) on, e.g., order rescheduling, order canceling, receiving user complaints, determining eligibility for appeasements relating to items of an order, making appeasements relating to items of an order, updating user data, etc. For example, if a service request is to cancel an order, a policy of the online system 140 regarding order cancelation may require that it be determined that the order is in fact eligible for cancelation for it to be cancelled. The policy may also detail what conditions are to be met in order for an order to be eligible for cancelation (e.g., ok to cancel an order so long as a picker has not started shopping for the order). The policy may also detail steps that occur if the order is not eligible for cancelation (e.g., notify user that order cannot be cancelled) and steps that occur if the order is eligible for cancelation (e.g., cancel the order). In some embodiments, there may be additional policies that pertain to handling special orders (e.g., do not allow cancelation after a shortened time window and/or have some other special rule) and/or for charge cancellation fees (e.g., maybe cancelling an order is allowed even if the picker has started shopping for an order if a fee is paid) such that the sequence has different actions.

The planning and execution module 228 may communicate with user client devices via online chat sessions. For example, the planning and execution module 228 may include a chatbot that manages online chat sessions with various user client devices. The chatbot may be composed of one or more machine-learning models. The chatbot may be trained to identify service requests in communications with the user client devices. In some embodiments, the chatbot may also be configured to notify user client devices regarding resolution of the service requests. The notification may be as part of the online chat session, via email, via phone, via text message, etc.

The planning and execution module 228 processes service requests received from user client devices. The planning and execution module 228 includes a planning AI agent 270. The planning AI agent 270 may be composed of one or more machine learned models. The one or more machine learned models may be tuned using in part the policies in the policy database 260. The planning and execution module 228 may use the planning AI agent 270 to determine sequences of actions that address received service requests (e.g., received from the chatbot and/or the user client devices). For example, for a given service request (e.g., "cancel my order"), the planning and execution module 228 may prompt the planning AI agent 270 to generate, using the policy database 260, a sequence of actions to address the service request. The planning AI agent 270 may search the policy database 260 for guidance on determining actions that if followed could resolve the service request. In some embodiments, the planning AI agent 270 may use embedding similarity (e.g., between the service request and the policies) and/or keyword matching (e.g., "cancel," "order") to search the policy database 260 based on the service request. In some embodiments, the planning AI agent 270 automatically analyzes retrieved policies to determine a sequence of one or more actions to respond to the service request. In other embodiments, the planning and execution module 228 may prompt the planning AI agent 270 to analyze the retrieved policies to determine a sequence of one or more actions to respond to the service request. The planning and execution module 228 outputs the sequence of one or more actions to respond to the service request.

The sequence of one or more actions is just a series of steps that if taken, should resolve the service request. Each of the actions may be a textual description of a step in the sequence. For example, if the service request were to “cancel my order,” the planning and execution module 228 may generate a sequence having two actions to respond to the service request. The first action may be to “check eligibility of order for cancellation,” and the second action of the sequence may be to “cancel the order.” In this example if step one fails, then the sequence would not move to step two. As such, at this stage there is a plan to respond to the service request, but the functions (e.g., API calls) used to execute each step of the plan have not been identified.

The planning and execution module 228 identifies functions to perform sequences of actions using the action library 280. For each action of a sequence, the planning and execution module 228 may compute similarity scores for that action with some or all of the action entries of the action library 280. A similarity score describes how well an action matches an action entry. A similarity score may be based on, e.g., embedding similarity (e.g., between the action and one or more fields of an action entry) and/or keyword matching (e.g., words in the action and the one or more fields of the action entry). In some embodiments, the similarity score may be based in part on content of the description of the action entry (e.g., keyword matching between words in the action and words in the description of the action entry). For a single action there is a plurality of similarity scores, where each respective similarity score is associated with a similarity between the action and a different action entry. The planning and execution module 228 may select an action entry that corresponds to the action based in part on the similarity scores. For example, the planning and execution module 228 may rank, for the action, the action entries by the similarity scores, and select the action entry having the highest score. The planning and execution module 228 may do this for each action of a sequence to determine for each action of the sequence a corresponding action entry. Each of the action entries correspond to different functions (e.g., API calls), as such, each action of a sequence has a corresponding action entry that corresponds to a function (e.g., API call).

The planning and execution module 228 executes identified APIs of sequences using an execution AI agent 290. The planning and execution module 228 may include the execution AI agent 290. The execution AI agent 290 may be composed of one or more machine-learning models (e.g., large language models). The planning and execution module 228 may use the execution AI agent 290 to execute the identified APIs of sequences (e.g., in order to resolve service requests). In some embodiments, the planning AI agent 270 is composed of a plurality of machine learning models (e.g., large language models). For example, there may be a first set of one or more large language models that are configured to execute functions (e.g., API calls), and a second set of one or more large language models that are configured to evaluate results of the first set.

The first set of one or more large language models may be configured to execute functions in accordance with identified functions of sequences. In some embodiments different large language models in the first set are configured to execute different functions. For example, a first large language model may be configured to execute an API for checking order eligibility, a second large language model may be configured to execute an API for canceling an order, etc. In some embodiments, a single large language model of the first set may be trained to execute a plurality of different functions (e.g., API calls). The execution AI agent 290 may identify a large language model of the one or more large language models in the first set that is associated with an API that was identified for a particular action entry of a sequence. The execution AI agent 290 may prompt the large language model to execute the identified API. As a result, the identified API successfully may execute, or an error may occur.

The second set of one or more large language models may be configured to evaluate results of the first set of one or more large language models. Evaluation of a result may include identifying an error that caused the result, and resolving the identified error. For example, a large language model in the first set may have performed an API call. A large language model in the second set may determine whether an error is in the result, and if not - prompt the large language model of the first set to proceed (e.g., execute API associated with next step of sequence). But if an error is present, the large language model of the second set may determine a cause of the error, attempt to resolve the cause of the error, and prompt the large language model in the first set to again perform the API call.

In some embodiments, if no error occurs in execution of a function (e.g., an API call) performed by a large language model in the first set, a large language model in the second set may prompt the large language model of the first set proceed with executing a function associated with the next action of the sequence. And if all functions for each of the actions of the sequence have successfully been performed or a resolution has been reached (e.g., it was determined that a requested task may not be performed), the planning and execution module 228 may proceed to notify (e.g., may instruct the chatbot to send a notification) the user client device that the service request has been resolved. But, if there is an error that occurred in execution of the function (e.g., API call) performed, the large language model of the second set may determine a cause of the error (e.g., improper format of user ID in call parameter field of action entry). The large language model of the second set may then correct the error (e.g., update format of the user ID in the call parameter of the action entry), and prompt the large language model of the first set to execute the function again.

In some embodiments, different large language models in the second set are configured to evaluate results from different functions. For example, a first large language model in the second set may be configured to evaluate results from a large language model (in the first set) that performed a first function, and a second large language model in the second set may be configured to evaluate results from the large language model (in the first set) that performed a second function that is different from the first function. In some embodiments, a single large language model of the second set is configured to evaluate results from one or more different large language models of the first set.

The machine-learning training module 230 trains machine-learning models (e.g., models of the translation AI agent 250, planning AI agent 270, and the execution AI agent 290) used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, service data, or order data, which may be referred to respectively as training user data, training picker data, training item data, training service data, and training order data. In some embodiments a training example may include, e.g., various errors associated with various functions (e.g., API calls) and/or action entries. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

For example, in some embodiments, the machine-learning training module 230 may train a machine-learning model of the planning AI agent 270 by accessing a set of training examples that includes training structured data describing the plurality of policies, and training service data for a plurality of service requests. The machine-learning training module 230 may apply the machine-learning model to the set of training examples to generate a training output corresponding to a set of training sequences of actions for at least some of the plurality of service requests. The machine-learning training module 230 may back-propagate one or more error terms obtained from one or more loss functions to update a set of parameters of the machine-learning model, and one or more of the error terms are based on a difference between a label applied to a test interaction of the set of training examples and the set of training sequences. The machine-learning training module 230 may stop the back-propagation after the one or more loss functions satisfy one or more criteria.

In some embodiments, the machine-learning training module 230 may tune one or more machine-learning models. For example, the machine-learning training module 230 may tune one or more machine-learning models of the execution AI agent 290 that evaluate results of API calls. For example, the machine-learning training module 230 may tune the one or more machine-learning models to identify errors in API calls, determine causes of the errors, and resolve the causes of errors.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, service data, structured data describing one or more APIs, and picker data for use by the online system 140. The data store 240 may also store the policy database 260 and/or the action library 280. In some embodiments, one or both of the policy database 260 and the action library 280 are separate from the data store 240. The data store 240 also stores trained machine-learning models trained by the machine-learning training module 230 (e.g., machine-learning models of the translation AI agent 250, the planning AI agent 270, and the execution AI agent 290). For example, the data store 240 may store the set of parameters for a trained machine-learning model on one or more non-transitory, computer-readable media. The data store 240 uses computer-readable media to store data, and may use databases to organize the stored data.

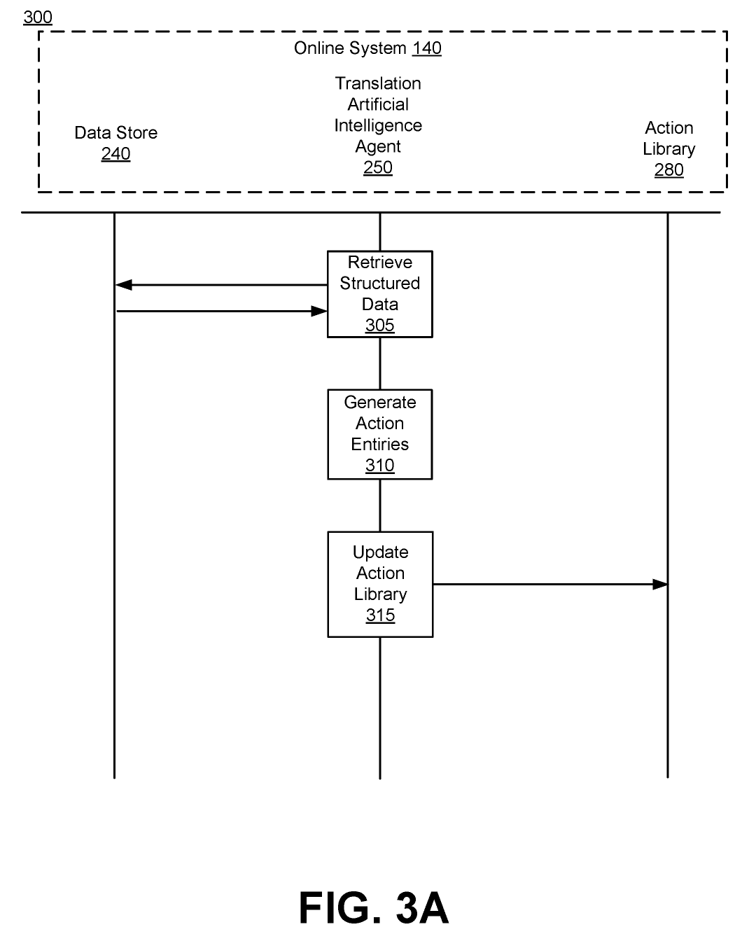

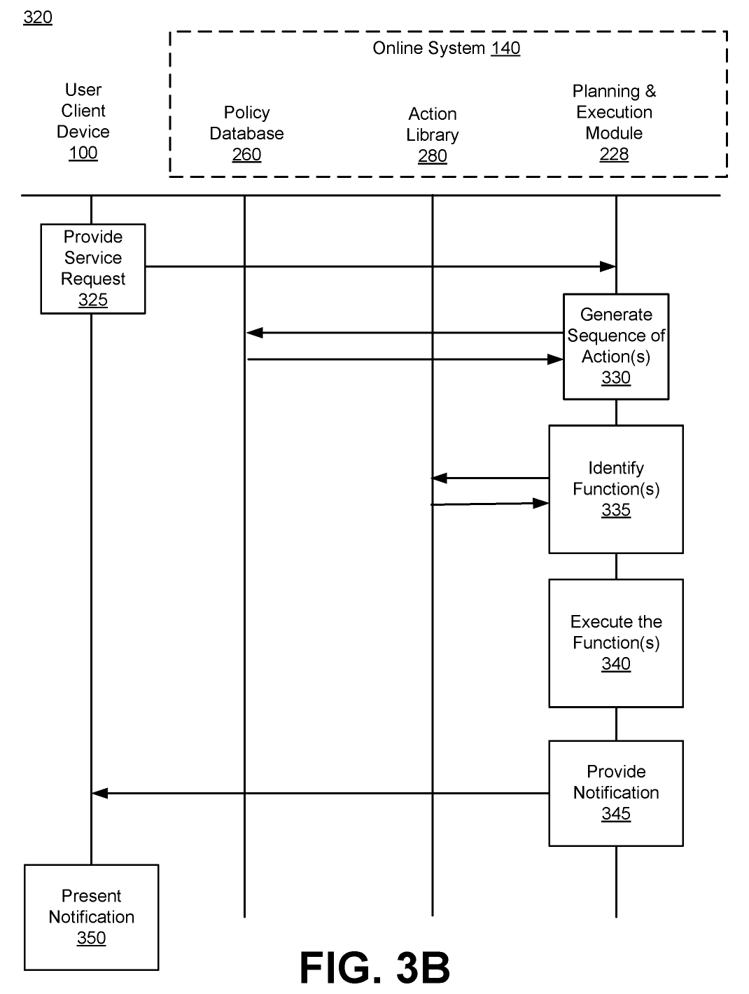

FIG. 3A is an example sequence diagram 300 describing updating an action library 280 using a translation AI agent 250, in accordance with some embodiments. Alternative embodiments may include more, fewer, or different interactions from those illustrated in FIG. 3A, and the steps may be performed in a different order from that illustrated in FIG. 3A.

The translation AI agent 250 retrieves 305 structured data (e.g., protobuf files) from the data store 240. The structured data may describe, e.g., interfaces of one or more APIs that can be performed by the online system 140.

The translation AI agent 250 generates 310 action entries using the structured data. The translation AI agent 250 parses the structured data to identify different functions. For example, the translation AI agent 250 may parse the structured data to identify APIs described therein. And for each of the identified functions, the translation AI agent 250 generates corresponding action entries. For example, for an identified API, the translation AI agent may generate an action entry that has a description, call parameters, and one or more sample calls.

The translation AI agent 250 updates 315 the action library 280 with the generated action entries. In this manner, the translation AI agent 250 can populate the action library 280 with action entries for some or all of the functions used by the online system 140.

FIG. 3B is an example sequence diagram 320 describing automated resolution of service requests from user client devices, in accordance with some embodiments. Alternative embodiments may include more, fewer, or different interactions from those illustrated in FIG. 3B, and the steps may be performed in a different order from that illustrated in FIG. 3B.

A user of a user client device 100 uses the user client device 100 to generate a service request. The service request requests that the online system 140 perform a task. For example, the service request may be to, e.g., reschedule an order associated with the user that had been placed with the online system 140. The user client device 100 provides 325 the service request to the online system 140 for resolution. For example, the user client device 100 may be in an online chat session with the online system 140 and provide the service request during the online chat session.

Responsive to receiving the service request, the planning and execution module 228 of the online system 140 may generate 330 a sequence of one or more actions to resolve the service request. The planning and execution module 228 may use a planning AI agent 270 to determine the sequence of one or more actions. The planning and execution module 228 may prompt the planning AI agent 270 to generate, using the policy database 260, a sequence of one or more actions to address the service request. The planning AI agent 270 searches the policy database 260 for guidance on actions that describe how to resolve the service request. In some embodiments, the planning AI agent 270 may use embedding similarity (e.g., between the service request and the policies) and/or keyword matching (e.g., "cancel," "order") to search the policy database 260 based on the service request. The planning AI agent 270 analyzes retrieved policies to determine a sequence of one or more actions that describe how to address the service request.

The planning and execution module 228 identifies 335 a function (e.g., API calls) for each of the actions of the sequence using the action library 280. For each action of the sequence, the planning and execution module 228 may compute similarity scores that compare that action with some or all of the action entries of the action library 280 and select an action entry from the action library 280 that has a highest similarity score. In this manner, the planning and execution module 228 identifies for each action of the sequence a respective action entry that is associated with its own function (e.g., API call).

The planning and execution module 228 executes 340 the identified one or more functions associated with the one or more actions of the sequence. The planning and execution module 228 uses an execution AI agent 290 to execute the identified one or more functions (e.g., API calls) and verify results of the executed functions.

For example, the identified one or more functions may be API calls. The execution AI agent 290 may include a first large language model configured to execute API calls, and a second large language model that is configured to evaluate results of the API calls. The first large language model may execute an API call for an API associated with a first action of the sequence. The second large language model evaluates a result of the API call. In some instances, there may be some error in an API being called by the first large language model. The second large language model may detect an error in the result. Responsive to detecting the error, the second large language model may determine a cause of the error and attempt to resolve the cause of the error. For example, the second large language model may determine that the error was caused by an improper call parameter that was specified in the action entry for that API. The second large language model may correct the call parameter in the action entry, and prompt the first large language model to call the API again using the corrected call parameter.

If no error is present, the first large language model performs a function that is associated with the next API in the sequence, and the second large language model evaluates a result of the execution of the function. This process continues until a resolution (e.g., order is rescheduled or it is determined that the order cannot be rescheduled) to the sequence has occurred. The online system 140 may then provide 345 a notification to the user client device 100 of the resolution, and the user client device 100 may present 350 the notification. For example, the online system 140 may provide the resolution via the online chat session.

The online system 140 is able to generate, for a given service request, a sequence of actions automatically in an autonomous manner using the policies of the online system 140. As such, a sequence of actions to resolve a service request can be generated based on specific domain knowledge of how to resolve the service request. Moreover, as the action library includes action entries for various functions that are available to the online system 140 - and is not just a text library. As such, the online system 140 is able to identify functions that map to the actions of a sequence, and the execution AI agent 290 is able to autonomously execute the identified functions in order to resolve the service request. Accordingly, the online system 140 is able to resolve a wide range of service requests automatically and autonomously, without intervention of an actual human agent of the online system 140.

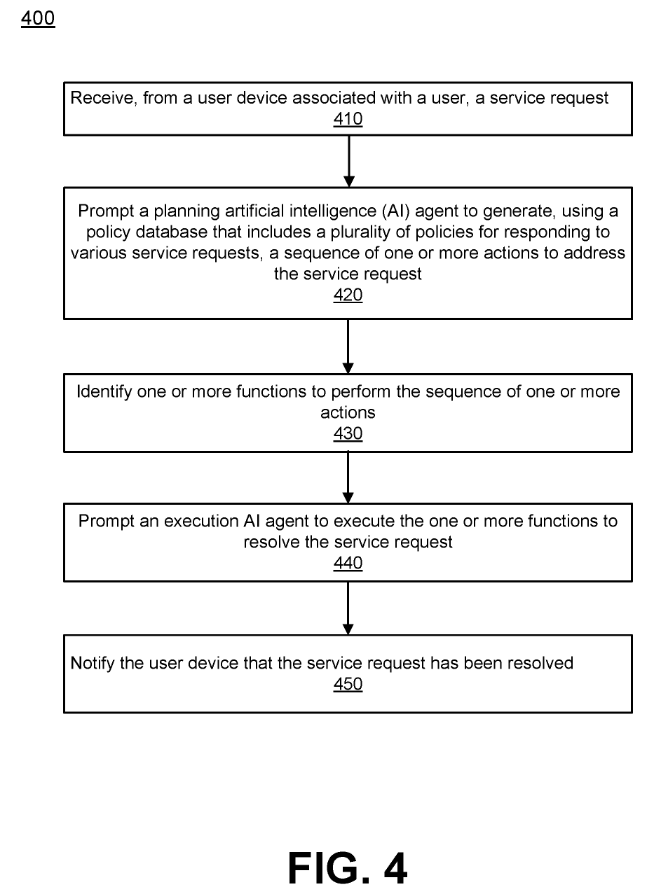

FIG. 4 is a flowchart 400 for a method of automated planning and execution of functions (e.g., API calls) using AI agents, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system receives 410, from a user device associated with a user, a service request. The user device may be, e.g., a user client device 100. The service request is a request for the online system to perform a particular task (e.g., cancel an order, reschedule an order, etc.).

The online system prompts 420 a planning AI agent (e.g., the planning AI agent 270) to generate, using a policy database (e.g., the policy database 260), a sequence of one or more actions to address the service request. The policy database may include a plurality of policies for responding to various service requests. The planning AI agent may search the policy database for guidance on a sequence of actions that describe how to resolve the service request. In some embodiments, the AI planning agent may use embedding similarity and/or keyword matching to search the policy database based on the service request. The AI planning agent may automatically analyze retrieved policies to determine the sequence of one or more actions to respond to the service request.

The online system identifies 430 one or more functions to perform the sequence of one or more actions. The online system may identify a function for each of the one or more actions using an action library (e.g., the action library 280). For example, for each action of the sequence, the online system may compute similarity scores for that action with some or all of the action entries of the action library, and select an action entry from the action library that has a highest similarity score. In some embodiments, the one or more functions are different API calls.

The online system prompts 440 an execution AI agent to execute the one or more functions to resolve the service request. The online system uses an execution AI agent (e.g., the execution AI agent 290) to execute functions (e.g., API calls) and verify results of the executed functions. For example, the execution AI agent 290 may include a first large language model configured to execute the functions, and a second large language model that is configured to evaluate results of the executed functions. The execution AI agent may execute the functions of the sequence until a resolution (e.g., task is performed or it is determined that the task cannot be performed) to the sequence has occurred.

The online system notifies 450 the user device that the service request has been resolved. The user device may present the notification to the user.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium of an online system, comprising:
receiving, from a user device associated with a user, a service request;
prompting a planning artificial intelligence (AI) agent to generate, using a policy database that includes a plurality of policies for responding to various service requests, a sequence of one or more actions to address the service request;
identifying one or more application programming interfaces (APIs) to perform the sequence of one or more actions;
prompting an execution AI agent to execute the one or more APIs to resolve the service request; and
notifying the user device that the service request has been resolved.

2. The method of claim 1, wherein the execution AI agent comprises a first large language model and a second large language model, and prompting the execution AI agent to execute the one or more APIs to resolve the service request comprises:
prompting the first large language model to perform an API call for an API of the one or more APIs; and
prompting the second large language model to evaluate a result of performing the API call.

3. The method of claim 2, further comprising:
identifying, by the second large language model, an error in the result, wherein the error is in a call parameter of the API;
determining a correction to the call parameter; and
prompting the first large language model to call the API using in part the correction to the call parameter.

4. The method of claim 1, further comprising:
prompting a translation AI agent to generate action entries for an action library using structured data that describes a plurality of APIs including the one or more APIs, where the action library includes an action entry for each of the plurality of APIs.

5. The method of claim 4, wherein identifying the one or more APIs to perform the sequence of one or more actions comprises:
for each action,
computing similarity scores between the action and each of the action entries of the action library, and
selecting an action entry to associate with the action that has a highest similarity score, wherein the action entry describes an API of the one or more APIs.

6. The method of claim 5, wherein computing the similarity scores between the action and each of the action entries of the action library, comprises:
computing similarity scores between the action and each description of the action entries.

7. The method of claim 1, wherein the planning AI agent comprises a machine-learning model that was trained by:
accessing a set of training examples that includes training structured data that includes the plurality of policies and training service data for a plurality of service requests;
applying the machine-learning model to the set of training examples to generate a training output corresponding to a set of training sequences of actions for at least some of the plurality of service requests;
back-propagating one or more error terms obtained from one or more loss functions to update a set of parameters of the machine-learning model, and one or more of the error terms are based on a difference between a label applied to a test interaction of the set of training examples and the set of training sequences; and
stopping the back-propagation after the one or more loss functions satisfy one or more criteria.

8. A computer program product comprising a non-transitory computer readable storage medium having instructions encoded thereon that, when executed by a processor of a computer system, cause the computer system to perform steps comprising:
receiving, from a user device associated with a user, a service request;
prompting a planning artificial intelligence (AI) agent to generate, using a policy database that includes a plurality of policies for responding to various service requests, a sequence of one or more actions to address the service request;
identifying one or more application programming interfaces (APIs) to perform the sequence of one or more actions;
prompting an execution AI agent to execute the one or more APIs to resolve the service request; and
notifying the user device that the service request has been resolved.

9. The computer program product of claim 8, wherein the execution AI agent comprises a first large language model and a second large language model, and prompting the execution AI agent to execute the one or more APIs to resolve the service request comprises:
prompting the first large language model to perform an API call for an API of the one or more APIs; and
prompting the second large language model to evaluate a result of performing the API call.

10. The computer program product of claim 9, further comprising encoded instructions that when executed cause the computer system to perform steps comprising:
identifying, by the second large language model, an error in the result, wherein the error is in a call parameter of the API;
determining a correction to the call parameter; and
prompting the first large language model to call the API using in part the correction to the call parameter.

11. The computer program product of claim 8, further comprising encoded instructions that when executed cause the computer system to perform steps comprising:
prompting a translation AI agent to generate action entries for an action library using structured data that describes a plurality of APIs including the one or more APIs, where the action library includes an action entry for each of the plurality of APIs.

12. The computer program product of claim 11, wherein the encoded instructions for identifying the one or more APIs to perform the sequence of one or more actions cause the computer system to perform steps comprising:
for each action,
computing similarity scores between the action and each of the action entries of the action library, and
selecting an action entry to associate with the action that has a highest similarity score, wherein the action entry describes an API of the one or more APIs.

13. The computer program product of claim 12, wherein the encoded instructions for computing the similarity scores between the action and each of the action entries of the action library, cause the computer system to perform steps comprising:
computing similarity scores between the action and each description of the action entries.

14. The computer program product of claim 8, wherein the planning AI agent comprises a machine-learning model that was trained by:
accessing a set of training examples that includes training structured data that includes the plurality of policies and training service data for a plurality of service requests;
applying the machine-learning model to the set of training examples to generate a training output corresponding to a set of training sequences of actions for at least some of the plurality of service requests;
back-propagating one or more error terms obtained from one or more loss functions to update a set of parameters of the machine-learning model, and one or more of the error terms are based on a difference between a label applied to a test interaction of the set of training examples and the set of training sequences; and
stopping the back-propagation after the one or more loss functions satisfy one or more criteria.

15. A computer system comprising:
a policy database that includes a plurality of policies for responding to various service requests;
a processor; and
a non-transitory computer readable storage medium having instructions encoded thereon that, when executed by the processor, cause the computer system to perform steps comprising:
receiving, from a user device associated with a user, a service request,
prompting a planning artificial intelligence (AI) agent to generate, using the policy database, a sequence of one or more actions to address the service request,
identifying one or more application programming interfaces (APIs) to perform the sequence of one or more actions,
prompting an execution AI agent to execute the one or more APIs to resolve the service request, and
notifying the user device that the service request has been resolved.

16. The computer system of claim 15, wherein the execution AI agent comprises a first large language model and a second large language model, and prompting the execution AI agent to execute the one or more APIs to resolve the service request comprises:
prompting the first large language model to perform an API call for an API of the one or more APIs; and
prompting the second large language model to evaluate a result of performing the API call.

17. The computer system of claim 16, further comprising encoded instructions that when executed cause the computer system to perform steps comprising:
identifying, by the second large language model, an error in the result, wherein the error is in a call parameter of the API;
determining a correction to the call parameter; and
prompting the first large language model to call the API using in part the correction to the call parameter.

18. The computer system of claim 15, further comprising:
an action library that includes actions entries that are associated with different APIs; and
encoded instructions that when executed cause the computer system to perform steps comprising:
prompting a translation AI agent to generate an action entry for the action library using structured data that describes an API of the one or more APIs.

19. The computer system of claim 18, wherein the encoded instructions for identifying the one or more APIs to perform the sequence of one or more actions cause the computer system to perform steps comprising:
for each action,
computing similarity scores between the action and each of the action entries of the action library, and
selecting an action entry to associate with the action that has a highest similarity score, wherein the action entry describes an API of the one or more APIs.

20. The computer system of claim 19, wherein the encoded instructions for computing the similarity scores between the action and each of the action entries of the action library, cause the computer system to perform steps comprising:
computing similarity scores between the action and each description of the action entries.
